(19) United States
(12) Patent Application Publication
(10) Pub. No.: US 2025/0016548 A1
(43) Pub. Date: Jan. 9, 2025

(54) FAST TRANSITION FRAME EXCHANGES FOR MULTI-LINK OPERATION

(71) Applicant: QUALCOMM Incorporated, San Diego, CA (US)

(72) Inventors: Sai Yiu Duncan HO, San Diego, CA (US); Abhishek Pramod PATIL, San Diego, CA (US); Gaurang NAIK, San Diego, CA (US); Jouni Kalevi MALINEN, Tuusula (FI); Adil Saeed MUSTHAFA, Milpitas, CA (US); George CHERIAN, San Diego, CA (US); Alfred ASTERJADHI, San Diego, CA (US); Abdel Karim AJAMI, San Diego, CA (US); Yanjun SUN, San Diego, CA (US)

(21) Appl. No.: 18/346,636

(22) Filed: Jul. 3, 2023

(51) Int. Cl. H04W 8/26; H04L 61/50; H04W 76/11

(52) U.S. Cl. CPC H04W 8/26; H04L 61/50; H04W 76/11; H04L 2101/622

(57) ABSTRACT

This disclosure provides methods, components, devices, and systems that support fast transition frame exchanges for multi-link operation. Some aspects more specifically relate to an over-the-Distribution System (DS) Fast Basic Service Set (BSS) Transition (FT) protocol for multi-link operation (MLO). In some implementations, a first wireless device may transmit a first frame that indicates a medium access control (MAC) address of a first wireless station (STA) affiliated with the first wireless device, a communication link on which the first wireless STA intends to communicate with a second wireless STA affiliated with a second wireless device, or both. The first wireless device may receive a second frame that indicates a MAC address of the second wireless STA, the communication link on which the second wireless STA intends to communicate with the first wireless STA, or both. The first and second frames may be exchanged according to an over-the-DS FT protocol.

### TECHNICAL FIELD

This disclosure relates to wireless communication and, more specifically, to fast transition frame exchanges for multi-link operation (MLO).

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

In some networks, a STA associated with a first AP may reassociate with a second AP. To do so, the STA may exchange frames with the second AP over-the-air (OTA) or over-the-Distribution System (DS). However, some reassociation schemes may not be optimized for multi-link operation (MLO).

### SUMMARY

The systems, methods, and devices of this disclosure each have several innovative aspects, no single one of which is solely responsible for the desirable attributes disclosed herein.

One innovative aspect of the subject matter described in this disclosure can be implemented in a first wireless device. The first wireless device may include one or more memories storing processor-executable code, and one or more processors coupled with the one or more memories. The one or more processors may, individually or collectively, be operable to execute the code to cause the first wireless device to: transmit, via a second communication link between the first wireless device and a third wireless device, a first frame that includes at least one of a first medium access control (MAC) address of a first wireless station (STA) affiliated with the first wireless device or a link identifier associated with a first communication link on which the first wireless STA intends to communicate with a second wireless STA affiliated with a second wireless device; and receive, via the second communication link between the first wireless device and the third wireless device, a second frame that includes at least one of a second MAC address of the second wireless STA or the link identifier associated with the first communication link on which the second wireless STA intends to communicate with the first wireless STA.

Another innovative aspect of the subject matter described in this disclosure can be implemented in a method for wireless communication by a first wireless device. The method may include: transmitting, via a second communication link between the first wireless device and a third wireless device, a first frame that includes at least one of a first MAC address of a first wireless STA affiliated with the first wireless device or a link identifier associated with a first communication link on which the first wireless STA intends to communicate with a second wireless STA affiliated with a second wireless device; and receiving, via the second communication link between the first wireless device and the third wireless device, a second frame that includes at least one of a second MAC address of the second wireless STA or the link identifier associated with the first communication link on which the second wireless STA intends to communicate with the first wireless STA.

One innovative aspect of the subject matter described in this disclosure can be implemented in a second wireless device for wireless communication. The second wireless device may include one or more memories storing processor-executable code, and one or more processors coupled with the one or more memories. The one or more processors may, individually or collectively, be operable to execute the code to cause the second wireless device to: receive, via a third communication link between the second wireless device and a third wireless device, a first frame that includes at least one of a first MAC address of a first wireless STA affiliated with a first wireless device or a link identifier associated with a first communication link on which the first wireless STA intends to communicate with a second wireless STA affiliated with the second wireless device; and transmit, via the third communication link between the second wireless device and the third wireless device, a second frame that includes at least one of a second MAC address of the second wireless STA or the link identifier associated with the first communication link on which the second wireless STA intends to communicate with the first wireless STA.

Another innovative aspect of the subject matter described in this disclosure can be implemented in a method for wireless communication by a second wireless device. The method may include: receiving, via a third communication link between the second wireless device and a third wireless device, a first frame that includes at least one of a first MAC address of a first wireless STA affiliated with a first wireless device or a link identifier associated with a first communication link on which the first wireless STA intends to communicate with a second wireless STA affiliated with the second wireless device; and transmitting, via the third communication link between the second wireless device and the third wireless device, a second frame that includes at least one of a second MAC address of the second wireless STA or the link identifier associated with the first communication link on which the second wireless STA intends to communicate with the first wireless STA.

In some implementations, the first frame includes a first Fast Basic Service Set (BSS) Transition (FT) Action frame, and the second frame includes a second FT Action frame.

In some implementations, a Link ID subfield of a STA Control field in a Per-STA Profile subelement of a Link Info field in a Multi-Link element of the first FT Action frame includes the link identifier associated with the first communication link on which the first wireless STA intends to communicate with the second wireless STA.

In some implementations, a STA MAC Address subfield of a STA Info field in a Per-STA Profile subelement of a Link Info field in a Multi-Link element of the first FT Action frame includes the first MAC address of the first wireless STA affiliated with the first wireless device.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows a pictorial diagram of an example wireless local area network (WLAN).

FIG. 2 shows an example network diagram that that supports fast transition frame exchanges for multi-link operation (MLO).

FIG. 3 shows a hierarchical format of an example Multi-Link element usable for communications between wireless devices that support fast transition frame exchanges for MLO.

FIG. 4 shows an example process flow that supports fast transition frame exchanges for MLO.

FIG. 5 shows a block diagram of an example wireless communication device that supports fast transition frame exchanges for MLO.

FIG. 6 shows a block diagram of an example wireless communication device that supports fast transition frame exchanges for MLO.

FIGS. 7 and 8 show flowcharts illustrating example processes that support fast transition frame exchanges for MLO.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others.

The described examples can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO. The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IoT) network.

In some WLANs, a wireless station (STA) associated with a first access point (AP) may reassociate with a second AP based on, for example, a location of the STA relative to the first AP, a location of the STA relative to the second AP, a signal strength associated with the second AP, a signal strength associated with the first AP, and so on. To reassociate with the second AP, the STA may communicate with the second AP directly (for example, via an over-the-air (OTA) link between the STA and the second AP) or indirectly (for example, via a backhaul link between the first AP and the second AP). However, some reassociation schemes may not be optimized for multi-link operations (MLO), where one multi-link device (MLD) can include or otherwise be affiliated with multiple STAs that operate on different communication links (such as a 2.4 gigahertz (GHz) channel and a 5 GHz channel). For example, if a non-AP MLD affiliated with two STAs wants to transition from one AP MLD to another, it may be unclear which STA will send the reassociation request and which communication link the STA will use to send the reassociation request.

Various aspects relate generally to over-the-Distribution System (DS) frame exchanges between MLDs. Some aspects more specifically relate to fast basic service set (BSS) transition (FT) frame exchanges between two or more MLDs (referred to hereinafter as wireless devices). In some implementations, a first wireless device (such as a non-AP MLD) may transmit a first frame (such as an FT Request frame) that includes a first medium access control (MAC) address of a first wireless STA affiliated with the first wireless device, a link identifier associated with a first communication link on which the first wireless STA intends to communicate with a second wireless STA affiliated with a second wireless device (such as a target AP MLD), or both. The contents of the first frame may be provided to the second wireless device over-the-DS. For example, the first wireless device may transmit the first frame to a third wireless device (such as a current AP MLD) via a second communication link (for example, an OTA link), and the third wireless device may forward (for example, relay, re-transmit) the first frame to the second wireless device via a third communication link (for example, a backhaul connection).

Accordingly, the second wireless device may transmit a second frame (such as an FT Response frame) that includes a second MAC address of the second wireless STA (such as a target AP) affiliated with the second wireless device, the link identifier associated with the first communication link on which the second wireless STA intends to communicate with the first wireless STA affiliated with the first wireless device, or both. As with the first frame, the contents of the second frame may be passed over-the-DS. For example, the second wireless device may transmit the second frame to the third wireless device via the third communication link, and the third wireless device may forward (for example, relay) the second frame to the first wireless device via the second communication link.

Upon receiving the second frame, the first wireless STA may transmit a third frame (such as a Reassociation Request frame) to the second wireless STA via the first communication link (such as an OTA link). In turn, the second wireless STA may transmit a fourth frame (such as a Reassociation Response frame) to the first wireless STA via the first communication link, thereby enabling the first wireless STA to reassociate with the second wireless STA. Although some aspects are explained in the context of FT frame exchanges, the techniques described herein can be applied to other communication schemes, such as seamless roaming in ultra-high reliability (UHR), where a non-AP STA can initiate roaming with an AP in the same Seamless (roaming) Mobility Domain. Likewise, although some aspects are explained in the context of an over-the-DS frame exchange (between the first wireless device and the second wireless device), the described techniques can be applied to OTA frame exchanges as well.

Particular aspects of the subject matter described in this disclosure can be implemented to realize one or more of the following potential advantages. Configuring the first wireless device to include the first MAC address of the first wireless STA and/or the link identifier of the first communication link in the first frame may enable the second wireless device to determine or otherwise identify the particular STA from which to expect a Reassociation Request frame and the particular communication link on which to expect the Reassociation Request frame, thereby improving the likelihood of the Reassociation Request frame being successfully received. The described techniques also may improve the security of reassociation schemes, as knowing the identity of the first wireless STA may enable the second wireless device to mitigate replay attacks, man-in-the-middle attacks, etc.

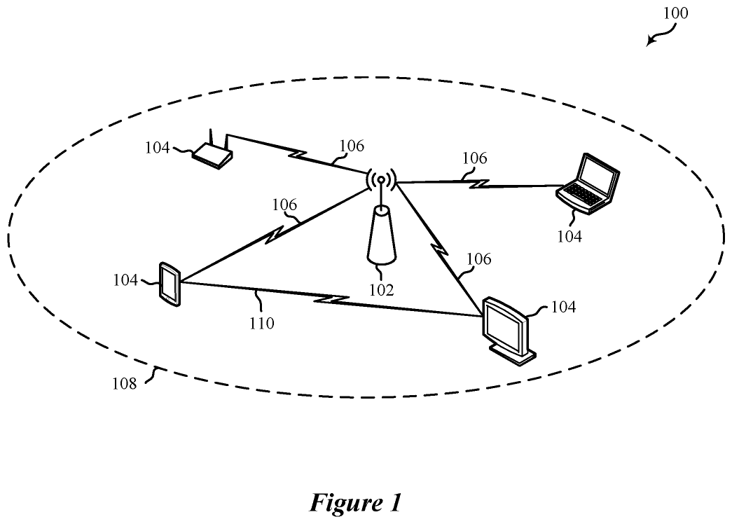

FIG. 1 shows a pictorial diagram of an example WLAN 100. According to some aspects, the WLAN 100 can be an example of a Wi-Fi network. For example, the WLAN 100 can be a network implementing at least one of the IEEE 802.11 family of wireless communication protocol standards (such as that defined by the IEEE 802.11-2020 specification or amendments thereof including, but not limited to, 802.11ay, 802.11ax, 802.11az, 802.11ba, 802.11bd, 802.11be, 802.11bf, and 802.11bn). The WLAN 100 may include numerous wireless communication devices such as a wireless AP 102 and multiple wireless STAs1. While only one AP 102 is shown in FIG. 1, the WLAN 100 also can include multiple APs 102. The AP 102 shown in FIG. 1 can represent various different types of APs including, but not limited to, enterprise-level APs, single-frequency APs, dual-band APs, standalone APs, software-enabled APs (soft APs), and multi-link APs. The coverage area and capacity of a cellular network (such as LTE, 5G NR, etc.) can be further improved by a small cell which is supported by an AP 102 serving as a miniature base station. Furthermore, private cellular networks also can be set up through a wireless area network using small cells.

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, personal digital assistant (PDAs), other handheld devices, netbooks, notebook computers, tablet computers, laptops, chromebooks, extended reality (XR) headsets, wearable devices, display devices (for example, TVs (including smart TVs), computer monitors, navigation systems, among others), music or other audio or stereo devices, remote control devices (“remotes”), printers, kitchen appliances (including smart refrigerators) or other household appliances, key fobs (for example, for passive keyless entry and start (PKES) systems), Internet of Things (IoT) devices, and vehicles, among other examples. The various STAs 104 in the network are able to communicate with one another via the AP 102.

A single AP 102 and an associated set of STAs 104 may be referred to as a BSS, which is managed by the respective AP 102. FIG. 1 additionally shows an example coverage area 108 of the AP 102, which may represent a basic service area (BSA) of the WLAN 100. The BSS may be identified or indicated to users by a service set identifier (SSID), as well as to other devices by a basic service set identifier (BSSID), which may be a MAC address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function for establishing or maintaining timing synchronization with the AP 102. The AP 102 may provide access to external networks to various STAs 104 in the WLAN via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHZ, 6 GHz or 60 GHz bands). To perform passive scanning, a STA 104 listens for beacons, which are transmitted by respective APs 102 at a periodic time interval referred to as the target beacon transmission time (TBTT) (measured in time units (TUs) where one TU may be equal to 1024 microseconds (μs)). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. An extended network station associated with the WLAN 100 may be connected to a wired or wireless distribution system that may allow multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some implementations, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some implementations, ad hoc networks may be implemented within a larger wireless network such as the WLAN 100. In such examples, while the STAs 104 may be capable of communicating with each other through the AP 102 using communication links 106, STAs 104 also can communicate directly with each other via direct wireless communication links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

The APs 102 and STAs 104 may function and communicate (via the respective communication links 106) according to one or more of the IEEE 802.11 family of wireless communication protocol standards. These standards define the WLAN radio and baseband protocols for the PHY and MAC layers. The APs 102 and STAs 104 transmit and receive wireless communications (hereinafter also referred to as “Wi-Fi communications” or “wireless packets”) to and from one another in the form of PHY protocol data units (PPDUs). The APs 102 and STAs 104 in the WLAN 100 may transmit PPDUs over an unlicensed spectrum, which may be a portion of spectrum that includes frequency bands traditionally used by Wi-Fi technology, such as the 2.4 GHZ band, the 5 GHz band, the 60 GHz band, the 3.6 GHz band, and the 900 MHz band. Some implementations of the APs 102 and STAs 104 described herein also may communicate in other frequency bands, such as the 5.9 GHZ and the 6 GHz bands, which may support both licensed and unlicensed communications. The APs 102 and STAs 104 also can communicate over other frequency bands such as shared licensed frequency bands, where multiple operators may have a license to operate in the same or overlapping frequency band or bands.

Each of the frequency bands may include multiple sub-bands or frequency channels. For example, PPDUs conforming to the IEEE 802.11n, 802.11ac, 802.11ax and 802.11be standard amendments may be transmitted over the 2.4 GHZ, 5 GHz or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHZ, 80 MHz. 160 or 320 MHz by bonding together multiple 20 MHz channels.

Each PPDU is a composite structure that includes a PHY preamble and a payload in the form of a PHY service data unit (PSDU). The information provided in the preamble may be used by a receiving device to decode the subsequent data in the PSDU. In instances in which PPDUs are transmitted over a bonded channel, the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 protocol to be used to transmit the payload.

Some wireless communication devices (including both APs 102 and STAs 104) are capable of MLO. In some implementations, MLO supports establishing multiple different communication links (such as a first link on the 2.4 GHz band, a second link on the 5 GHz band, and the third link on the 6 GHz band) between the STA 104 and the AP 102. Each communication link may support one or more sets of channels or logical entities. In some implementations, each communication link associated with a given wireless communication device may be associated with a respective radio of the wireless communication device, which may include one or more transmit/receive (Tx/Rx) chains, include or be coupled with one or more physical antennas, or include signal processing components, among other components. An MLO-capable device may be referred to as an MLD. For example, an AP MLD may include multiple APs 102 each configured to communicate on a respective communication link with a respective one of multiple STAs 104 of a non-AP MLD (also referred to as a “STA MLD”). The STA MLD may communicate with the AP MLD over one or more of the multiple communication links at a given time.

One type of MLO is multi-link aggregation (MLA), where traffic associated with a single STA 104 is simultaneously transmitted across multiple communication links in parallel to maximize the utilization of available resources to achieve higher throughput. That is, during at least some duration of time, transmissions or portions of transmissions may occur over two or more links in parallel at the same time. In some implementations, the parallel wireless communication links may support synchronized transmissions. In some other examples, or during some other durations of time, transmissions over the links may be parallel, but not be synchronized or concurrent. In some implementations or durations of time, two or more of the links may be used for communications between the wireless communication devices in the same direction (such as all uplink or all downlink). In some other examples or durations of time, two or more of the links may be used for communications in different directions. For example, one or more links may support uplink communications and one or more links may support downlink communications. In such examples, at least one of the wireless communication devices operates in a full duplex mode. Generally, full duplex operation enables bi-directional communications where at least one of the wireless communication devices may transmit and receive at the same time.

MLA may be implemented in a number of ways. In some implementations. MLA may be packet-based. For packet-based aggregation, frames of a single traffic flow (such as all traffic associated with a given traffic identifier (TID)) may be sent concurrently across multiple communication links. In some other examples, MLA may be flow-based. For flow-based aggregation, each traffic flow (such as all traffic associated with a given TID) may be sent using a single one of multiple available communication links. As an example, a single STA MLD may access a web browser while streaming a video in parallel. The traffic associated with the web browser access may be communicated over a first communication link while the traffic associated with the video stream may be communicated over a second communication link in parallel (such that at least some of the data may be transmitted on the first channel concurrently with data transmitted on the second channel).

In some other examples, MLA may be implemented as a hybrid of flow-based and packet-based aggregation. For example, an MLD may employ flow-based aggregation in situations in which multiple traffic flows are created and may employ packet-based aggregation in other situations. The determination to switch among the MLA techniques or modes may additionally, or alternatively, be associated with other metrics (such as a time of day, traffic load within the network, or battery power for a wireless communication device, among other factors or considerations).

To support MLO techniques, an AP MLD and a STA MLD may exchange supported MLO capability information (such as supported aggregation type or supported frequency bands, among other information). In some implementations, the exchange of information may occur via a beacon signal, a probe request or probe response, an association request or an association response frame, a dedicated action frame, or an operating mode indicator (OMI), among other examples. In some implementations, an AP MLD may designate a given channel in a given band as an anchor channel (such as the channel on which it transmits beacons and other management frames). In such examples, the AP MLD also may transmit beacons (such as ones which may contain less information) on other channels for discovery purposes.

MLO techniques may provide multiple benefits to a WLAN. For example, MLO may improve user perceived throughput (UPT) (such as by quickly flushing per-user transmit queues). Similarly, MLO may improve throughput by improving utilization of available channels and may increase spectral utilization (such as increasing the bandwidth-time product). Further, MLO may enable smooth transitions between multi-band radios (such as where each radio may be associated with a given RF band) or enable a framework to set up separation of control channels and data channels. Other benefits of MLO include reducing the ON time of a modem, which may benefit a wireless communication device in terms of power consumption. Another benefit of MLO is the increased multiplexing opportunities in the case of a single BSS. For example, multi-link aggregation may increase the number of users per multiplexed transmission served by the multi-link AP MLD.

In some implementations, a first wireless device (such as a non-AP MLD) may transmit a first frame (such as an FT Request frame) that includes a first MAC address of a first wireless STA 104 affiliated with the first wireless device, a link identifier associated with a first communication link on which the first wireless STA 104 intends to communicate with a second wireless STA 104 affiliated with a second wireless device (such as a target AP MLD), or both. The contents of the first frame may be provided to the second wireless device over-the-DS. For example, the first wireless device may transmit the first frame to a third wireless device (such as a current AP MLD) via a second communication link (for example, an OTA link), and the third wireless device may forward (for example, relay, re-transmit) the first frame to the second wireless device via a third communication link (for example, a backhaul connection).

Accordingly, the second wireless device may transmit a second frame (such as an FT Response frame) that includes a second MAC address of the second wireless STA 104 (such as a target AP 102) affiliated with the second wireless device, the link identifier associated with the first communication link on which the second wireless STA 104 intends to communicate with the first wireless STA 104 affiliated with the first wireless device, or both. As with the first frame, the contents of the second frame may be provided over-the-DS. For example, the second wireless device may transmit the second frame to the third wireless device via the third communication link, and the third wireless device may forward the second frame to the first wireless device via the second communication link. Upon receiving the second frame, the first wireless STA 104 may transmit a third frame (such as a Reassociation Request frame) to the second wireless STA 104 via the first communication link (such as an OTA link). In turn, the second wireless STA 104 may transmit a fourth frame (such as a Reassociation Response frame) to the first wireless STA 104 via the first communication link, thereby enabling the first wireless STA 104 to reassociate with the second wireless STA 104.

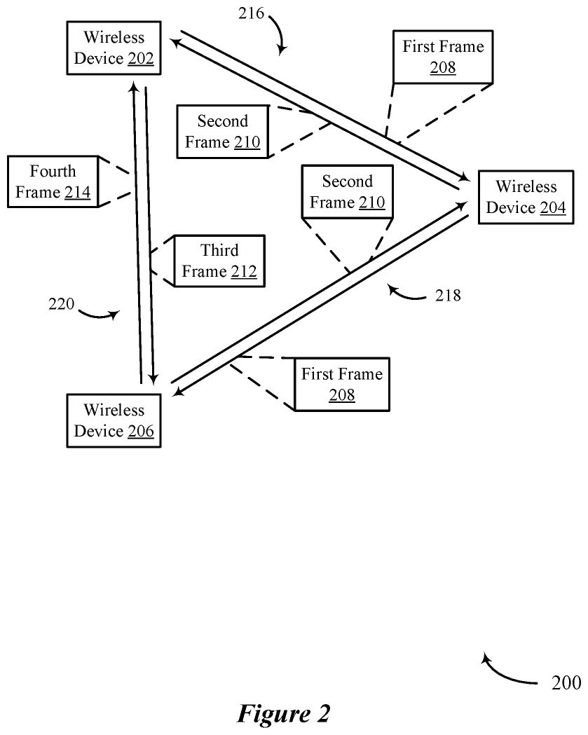

FIG. 2 shows an example network diagram 200 that supports fast transition frame exchanges for MLO. The network diagram 200 may implement or be implemented by aspects of the WLAN 100. For example, the network diagram 200 includes a wireless device 202, which may be affiliated with one or more wireless STAs, such as the STAs 104 shown and described with reference to FIG. 1. Likewise, the network diagram 200 includes a wireless device 204 and a wireless device 206, which may each be affiliated with one or more wireless APs, such as the AP 102 shown and described with reference to FIG. 1. In the network diagram 200, the wireless device 202 may communicate with the wireless device 204 and the wireless device 206 according to an over-the-DS protocol.

In the example of FIG. 2, the wireless device 202 (such as a non-AP MLD) may transmit a first frame 208 that includes a first MAC address of a first wireless STA (such as a non-AP STA) affiliated with the wireless device 202, a link identifier associated with a communication link 220 on which the first wireless STA intends to communicate with a second wireless STA (such as a first AP STA) affiliated with the wireless device 206 (such as a first AP MLD), or both. The contents of the first frame 208 may be provided to the wireless device 206 over-the-DS. For example, the wireless device 202 may transmit the first frame 208 to the wireless device 204 (such as a second AP MLD) via a communication link 216 (for example, an OTA link), and the wireless device 204 may forward (for example, relay, re-transmit) the first frame 208 to the wireless device 206 via a communication link 218 (for example, an Ethernet or backhaul connection).

Accordingly, the wireless device 206 may transmit a second frame 210 that includes a second MAC address of the second wireless STA, the link identifier associated with the communication link 220 on which the second wireless STA intends to communicate with the first wireless STA, or both. As with the first frame 208, the contents of the second frame 210 may be provided over-the-DS. For example, the wireless device 206 may transmit the second frame 210 to the wireless device 204 via the communication link 218, and the wireless device 204 may forward the second frame 210 to the wireless device 202 via the communication link 216. Upon receiving the second frame 210, the first wireless STA may transmit a third frame 212 to the second wireless STA via the communication link 220 (such as an OTA link). In turn, the second wireless STA may transmit a fourth frame 214 to the first wireless STA via the communication link 220, at which point the first wireless STA can reassociate with the second wireless STA (assuming the contents of the fourth frame 214 are valid).

In some implementations, the frame exchange depicted in the network diagram 200 may be a part of an over-the-DS FT protocol. For example, the first frame 208 may include a first FT Action frame (such as an FT Request frame or an FT Confirm frame), which may be relayed from the wireless device 202 (such as an FTO) to the wireless device 206 (such as a target FTR) via the wireless device 204 (such as a current FTR). Similarly, the second frame 210 may include a second FT Action frame (such as an FT Response frame or an FT Ack frame), which may be relayed from the wireless device 206 to the wireless device 202 via the wireless device 204. Although some aspects are explained in the context of FT frame exchanges, the techniques described herein are applicable to many other communication schemes, such as seamless roaming in UHR, where a non-AP STA can initiate roaming with another AP within the same Seamless (roaming) Mobility Domain. Likewise, although some aspects are explained in the context of an over-the-DS frame exchange, the described techniques can be applied to OTA frame exchanges as well.

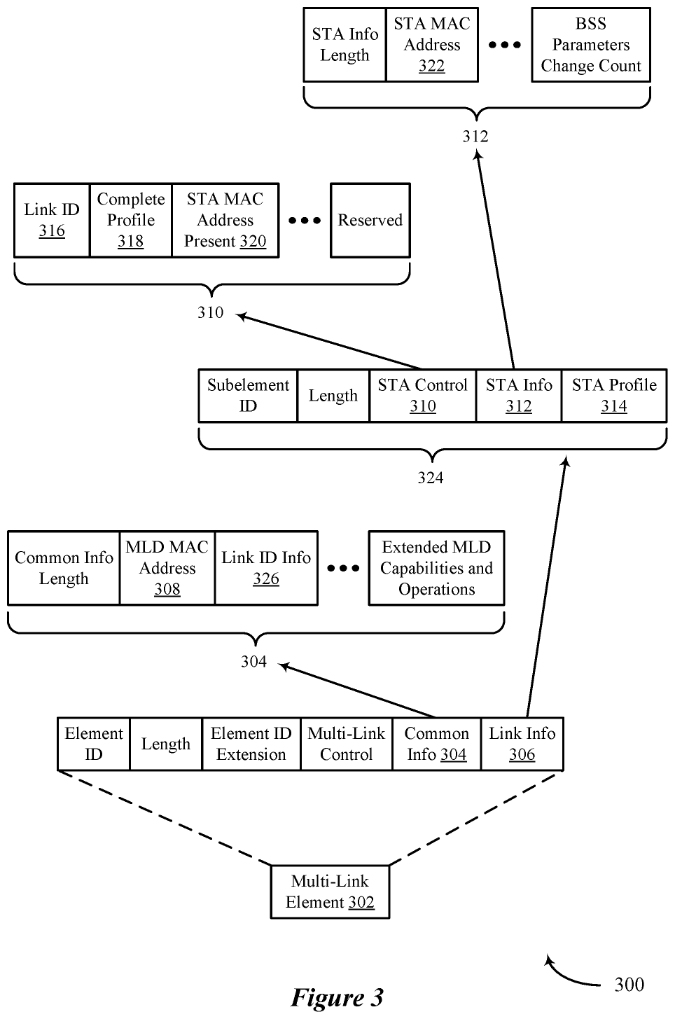

In some implementations, a STA affiliated with an MLD (such as the wireless device 202) may include a Multi-Link element (such as the Multi-Link element 302 shown and described with reference to FIG. 3) in an Authentication frame or FT Action frame (such as the first frame 208). The STA may include the MAC address of the MLD with which the STA is affiliated in the Common Info field (such as the Common Info field 304 shown and described with reference to FIG. 3) of the Multi-Link element. The STA may set all subfields in a Presence Bitmap subfield of a Multi-Link Control field of the Multi-Link element to 0.

The STA may not include a Link Info field (such as the Link Info field 306 shown and described with reference to FIG. 3) in the Multi-Link element if the frame is an Authentication frame. The STA may include the Link Info field in the Multi-Link element if the frame is an FT Action frame, in which case the Link Info field may include a Per-STA Profile subelement (such as the Per-STA Profile subelement 324 shown and described with reference to FIG. 3). All subfields of a STA Control field (such as the STA Control field 310 shown and described with reference to FIG. 3) in the Per-STA Profile subelement, except a Link ID subfield (such as the Link ID subfield 316 shown and described with reference to FIG. 3) and a STA MAC Address Present subfield (such as the STA MAC Address Present subfield 320 shown and described with reference to FIG. 3), may be set to 0.

The non-AP MLD (FTO) may discover link configuration information (such as enabled links or link IDs) of the target AP MLD (FTR) before the non-AP MLD initiates an FT Action frame exchange. For example, the wireless device 202 may receive (via a Beacon or Probe Response frame) an indication of one or more communication links enabled or supported by the wireless device 206. The FTR may transmit a Reassociation Response frame on the same communication link where the FTR receives a Reassociation Request frame from the FTO. For example, if the wireless device 206 receives the third frame 212 via the communication link 220, the wireless device 206 may transmit the fourth frame 214 via the communication link 220.

The Link ID subfield of the STA Control field may include a value that uniquely identifies the communication link on which the reported STA is operating (if the frame is not an FT Action frame), the communication link on which an FTO (such as the wireless device 202) will transmit the Reassociation Request frame (such as the third frame 212) if the frame is an FT Request or FT Confirm frame, or the communication link on which an FTR (such as the wireless device 206) will transmit a Reassociation Response frame (such as the fourth frame 214) if the frame is an FT Response or FT Ack frame.

If the frame is not an FT Action frame, a STA MAC Address subfield (such as the STA MAC Address subfield 322 shown and described with reference to FIG. 3) of a STA Info field (such as the STA Info field 312 shown and described with reference to FIG. 3) in the Per-STA Profile subelement of the Link Info field in the Multi-Link element may carry the MAC address of the STA that operates on the communication link identified by the Link ID subfield of the STA Control field and is affiliated with the same MLD as the STA that transmits the Multi-Link element. If the frame is an FT Request or FT Confirm frame, the STA MAC Address subfield may carry the MAC address of the STA that will transmit the Reassociation Request frame to the FTR and is affiliated with the FTO. Otherwise, if the frame is an FT Response or FT Ack frame, the STA MAC Address subfield may carry the MAC address of the STA that will transmit the Reassociation Response frame to the FTO and is affiliated with the FTR.

For MLO, the FTO may verify the Reassociation Response frame to ensure that the affiliated AP MAC address and all fields in the Robust Security Network Element (RSNE) and Robust Security Network Extension Element (RSNXE), if present, for each requested communication link are identical to those received for the corresponding affiliated APs of the AP MLD. Additionally, or alternatively, the FTO may verify the Reassociation Response frame to ensure that the affiliated AP MAC address and all fields in the RSNE and the RSNXE (if present) of other discovered links (if information is available) are identical to those received for the affiliated APs of the AP MLD. In other words, a non-AP STA may verify the contents of a Reassociation Response frame from a target AP to ensure that the contents are consistent with information provided in Beacon and Probe Response frames from AP(s) affiliated with the target AP MLD.

For Pairwise Transient Key Security Association (PTKSA) key generation/derivation with fast initial link setup (FILS), the inputs to the Pseudo-Random Function (PRF) are the Pairwise Master Key (PMK) of the PMK Security Association (PMKSA), a constant label, and a concatenation of the STA MAC address, the AP BSSID, the STA's nonce, and the AP's nonce. For MLO, the STA MAC address may be replaced with an MLD MAC address of an MLD affiliated with the STA. In other words, some security key derivation functions may use an MLD MAC address (for example, a MAC address of a higher-level logical entity) instead of a link MAC address associated with a particular STA.

FIG. 3 shows a hierarchical format 300 of an example Multi-Link element 302 usable for communications between wireless devices. The hierarchical format 300 of the Multi-Link element 302 may implement or be implemented by one or more aspects of the WLAN 100 or the network diagram 200. For example, a first wireless device (such as the wireless device 202 shown and described with reference to FIG. 2) may include the Multi-Link element 302 in a first frame (such as the first frame 208 shown and described with reference to FIG. 2) and transmit the first frame to a second wireless communication device (such as the wireless device 206 shown and described with reference to FIG. 2) according to an over-the-DS protocol. In some implementations, the Multi-Link element 302 may include a Basic Multi-Link element. Although some aspects are explained in the context of a Basic Multi-Link element structure/format, the techniques described herein are also applicable to other Multi-Link element variants. For example, the Multi-Link element 302 may be a dedicated Multi-Link element that is passed from a current AP (or FTR) to a target AP (or FTR) via the DS. Additionally, or alternatively, the information carried in the Multi-Link element 302 may be provided via another element specific to or otherwise defined for FT frame exchanges over-the-DS.

The Multi-Link element 302 may include an Element ID field, a Length field, an Element ID Extension field, a Multi-Link Control field, a Common Info field 304, and a Link Info field 306. The Common Info field 304 may include a Common Info Length subfield, an MLD MAC Address subfield 308, a Link ID Info subfield, and an Extended MLD Capabilities and Operations subfield, and other subfields (not shown). The Link Info field 306 may include at least one Per-STA Profile subelement 324 that includes one or more of a Subelement ID field, a Length field, a STA Control field 310, a STA Info field 312, or a STA Profile field 314. The STA Control field 310 may include a Link ID subfield 316, a Complete Profile subfield 318, a STA MAC Address Present subfield 320, a Reserved subfield, and other subfields (not shown). The STA Info field 312 may include a STA Info Length subfield, a STA MAC Address subfield 322, a BSS Parameters Change Count subfield, and other subfields (not shown).

As described with reference to FIGS. 1 and 2, a first wireless device may include a first Multi-Link element 302 in a first frame. The first Multi-Link element 302 may include a first MAC address of a first wireless STA affiliated with the first wireless device, a link identifier associated with a first communication link on which the first wireless STA intends to communicate with a second wireless STA affiliated with a second wireless device, or both. In some implementations, the first frame may include a first FT Action frame (such as an FT Request frame or an FT Confirm frame), which the first wireless device (such as an FTO) may transmit to a third wireless device (such as a current FTR) via a second communication link (such as an OTA link). In turn, the third wireless device may forward the first frame to the second wireless device (such as a target FTR) via a third communication link (such as an Ethernet or backhaul connection).

In some implementations, the Link ID subfield 316 of the STA Control field 310 in the Per-STA Profile subelement 324 of the Link Info field 306 in the first Multi-Link element 302 of the first frame may include the link identifier associated with the first communication link on which the first wireless STA intends to communicate with the second wireless STA. In some other implementations, the first wireless device may include the link identifier associated with the first communication link in the Link ID Info subfield 326 of the Common Info field 304. In some implementations, the link identifier in the Link ID subfield 316 of the STA Control field 310 may correspond to a preferred communication link of the first wireless device (such as a communication link on which a non-AP STA would prefer to transmit a Reassociation Request frame to a target AP). In some other implementations, the Link ID subfield 316 of the STA Control field 310 may be set to a reserved value (such as 15), in which case the second wireless device may disregard (for example, ignore) the Link ID subfield 316.

In some implementations, the STA MAC Address subfield 322 of the STA Info field in the Per-STA Profile subelement 324 of the Link Info field 306 in the first Multi-Link element 302 may include the first MAC address of the first wireless STA affiliated with the first wireless device. In some other implementations, the first wireless device may include the first MAC address of the first wireless STA in the MLD MAC Address subfield 308 of the Common Info field 304 in the first Multi-Link element 302 of the first frame. All subfields of the STA Control field 310 except for the Link ID subfield 316 and the STA MAC Address Present subfield 320 may be set to 0, and the STA Profile field 314 may optionally be included the Per-STA Profile subelement 324 of the Link Info field 306 in the first Multi-Link element 302 of the first frame. The Complete Profile subfield 318 of the STA Control field 310 also may be set to 0, indicating that the Per-STA Profile subelement 324 of the first Multi-Link element 302 in the first frame carries partial per-link information.

Accordingly, the second wireless device may include a second Multi-Link element 302 in a second frame (such as the second frame 210 shown and described with reference to FIG. 2). The second Multi-Link element 302 may include a second MAC address of the second wireless STA affiliated with the second wireless device, the link identifier associated with the first communication link on which the second wireless STA intends to communicate with the first wireless STA, or both. In some implementations, the second frame may include a second FT Action frame (such as an FT Response frame or an FT Ack frame), which the second wireless device (for example, the target FTR) may transmit to the third wireless device (for example, the current FTR) via the third communication link (such as the communication link 218 shown and described with reference to FIG. 2). In turn, the third wireless device may forward the second frame to the first wireless device (for example, the FTO) via the second communication link (such as the communication link 216 shown and described with reference to FIG. 2).

In some implementations, the Link ID subfield 316 of the STA Control field 310 in the Per-STA Profile subelement 324 of the Link Info field 306 in the second Multi-Link element 302 of the second frame may include the link identifier associated with the first communication link on which the second wireless STA intends to communicate with the first wireless STA. In some other implementations, the second wireless device may include the link identifier associated with the first communication link in the Link ID Info subfield 326 of the Common Info field 304. In some implementations, the link identifier in the Link ID subfield 316 of the STA Control field 310 may correspond to a preferred communication link of the second wireless device (such as a communication link on which a target AP STA would prefer to transmit a Reassociation Response frame to a non-AP STA), which may be the same or different from the preferred communication link of the first wireless device.

In some implementations, the STA MAC Address subfield 322 of the STA Info field in the Per-STA Profile subelement 324 of the Link Info field 306 in the second Multi-Link element 302 may include the second MAC address of the second wireless STA (such as a target AP STA). In some other implementations, the second device may include the second MAC address of the second wireless STA in the MLD MAC Address subfield 308 of the Common Info field 304 in the second Multi-Link element 302 of the second frame. All subfields of the STA Control field 310 except for the Link ID subfield 316 and the STA MAC Address Present subfield 320 may be set to 0, and the STA Profile field 314 may (in some implementations) be present in the Per-STA Profile subelement 324 of the Link Info field 306 in the second Multi-Link element 302 of the second frame. The Complete Profile subfield 318 of the STA Control field 310 also may be set to 0, indicating that the Per-STA Profile subelement 324 of the second Multi-Link element 302 in the second frame carries partial per-link information.

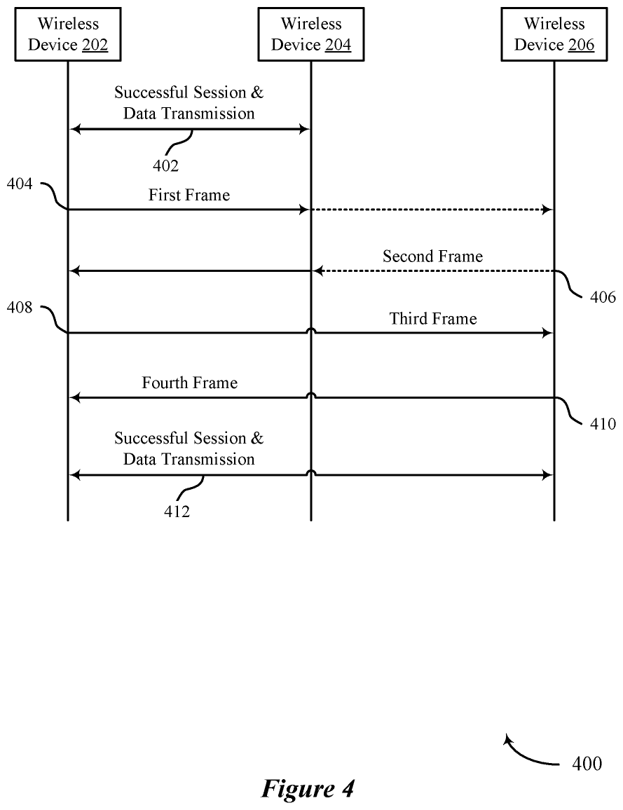

FIG. 4 shows an example process flow 400 that supports fast transition frame exchanges for MLO. The process flow 400 may implement or be implemented by aspects of the WLAN 100, the network diagram 200, or the hierarchical format 300, as shown and described with reference to FIGS. 1-3. For example, the process flow 400 includes the wireless device 202, the wireless device 204, and the wireless device 206 shown and described with reference to FIG. 2. In the following description of the process flow 400, operations between the wireless device 202, the wireless device 204, and the wireless device 206 may be added, omitted, or performed in a different order (with respect to the example order shown in FIG. 4).

At 402, the wireless device 202 (such as a non-AP MLD or an FTO) may establish a secure session with the wireless device 204 (such as a current AP MLD or current FTR). Once established, the wireless device 202 may exchange data with the wireless device 204 via a second communication link (such as the communication link 216 shown and described with reference to FIG. 2). In some implementations (for example, if the wireless device 202 and the wireless device 204 support MLO), two or more STAs (such as non-AP STAs) affiliated with the wireless device 202 may communicate with two or more STAs (such as AP STAs) affiliated with the wireless device 204 via respective communication links (such as a 2.4 GHz channel and an upper 5 GHz channel).

At 404, the wireless device 202 (also referred to as a first wireless device) may transmit a first frame (such as an FT Request frame or an FT Confirm frame) that includes a first MAC address of a first wireless STA affiliated with the wireless device 202, a link identifier associated with a first communication link on which the first wireless STA intends to communicate with a second wireless STA affiliated with the wireless device 206 (also referred to as a second wireless device), or both. The contents of the first frame may be provided to the wireless device 206 over-the-DS (for example, using an over-the-DS FT protocol). For example, the wireless device 202 may transmit the first frame to the wireless device 204 (also referred to as a third wireless device) via the second communication link, and the wireless device 204 may relay (for example, forward) the contents of the first frame to the wireless device 206 via a third communication link (such as a backhaul connection or DS link).

At 406, the wireless device 206 may transmit a second frame (such as an FT Response frame or an FT Ack frame) that includes a second MAC address of a second wireless STA (such as a target AP) affiliated with the wireless device 206, the link identifier associated with a first communication link on which the second wireless STA intends to communicate with the first wireless STA affiliated with the wireless device 202, or both. In some implementations, the first communication link may be the same as the first communication link. As with the first frame, the contents of the second frame may be provided to the wireless device 202 over-the-DS (for example, using an over-the-DS FT protocol). For example, the wireless device 206 may transmit the second frame to the wireless device 204 via the third communication link, and the wireless device 204 may forward the second frame to the wireless device 202 via the second communication link.

At 408, the first wireless STA affiliated with the wireless device 202 may transmit a third frame (such as a Reassociation Request frame) to the second wireless STA affiliated with the wireless device 206 via the first communication link (identified by the first frame). In some implementations, the third frame may include an RSNE, an RSNXE, an FT element (FTE), a Multi-Link element, and other parameters (such as a mobility domain element (MDE) and other security elements). At 410, the second wireless STA affiliated with the wireless device 206 may transmit a fourth frame (such as a Reassociation Response frame) to the first wireless STA affiliated with the wireless device 202 via the first communication link. Like the third frame, the fourth frame may include an RSNE, an RSNXE, an FTE, a Multi-Link element (such as the Multi-Link element 302 shown and described with reference to FIG. 3), and other parameters.

At 412, the first wireless STA affiliated with the wireless device 202 may establish a secure session with the second wireless STA affiliated with the wireless device 206. Once established, the first wireless STA may exchange data with the second wireless STA via the first communication link (and possibly other links if the wireless device 202 and the wireless device 206 both support MLO). In some implementations, the wireless device 202 may verify the contents of the fourth frame before establishing the secure session. For example, the wireless device 202 may verify, for each communication link associated with the wireless device 206, that all parameters and fields in the fourth frame correspond to AP STAs affiliated with the wireless device 206. The wireless device 202 may perform this verification process to ensure that the contents of the fourth frame are consistent with prior Beacon and Probe Response frames from AP STAs affiliated with the wireless device 206.

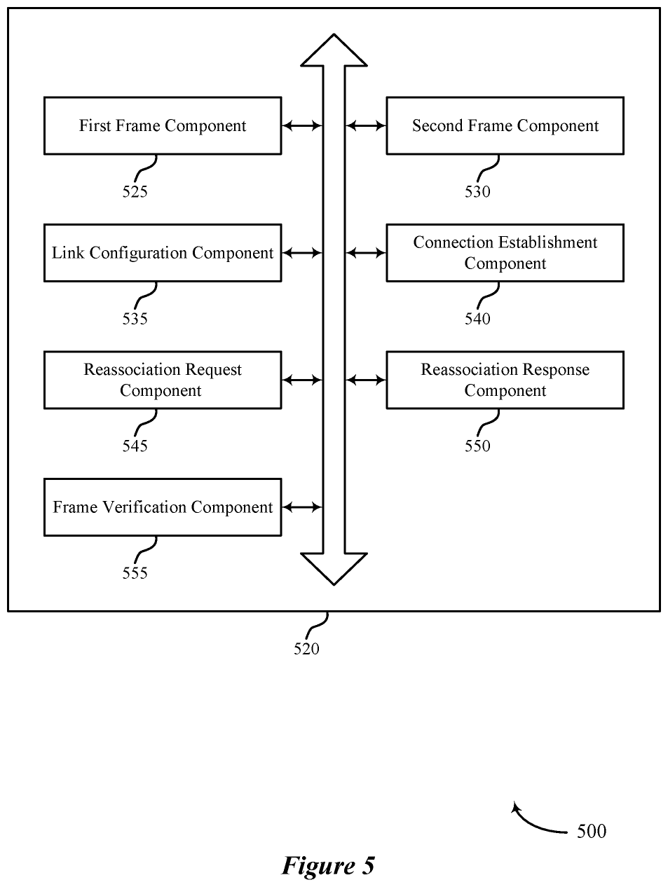

FIG. 5 shows a block diagram 500 of an example wireless device 520 that supports fast transition frame exchanges for MLO. The first wireless device 520 may be an example of aspects of a first wireless device, such as the wireless device 202 shown and described with reference to FIG. 2. The first wireless device 520, or various components thereof, may be an example of means for performing various aspects of fast transition frame exchanges for MLO as described herein. For example, the first wireless device 520 may include a first frame component 525, a second frame component 530, a link configuration component 535, a connection establishment component 540, a reassociation request component 545, a reassociation response component 550, a frame verification component 555, or any combination thereof. Each of these components, or components or subcomponents thereof (for example, one or more processors, one or more memories), may communicate, directly or indirectly, with one another (for example, via one or more buses).

The first wireless device 520 may support wireless communication in accordance with examples disclosed herein. The first frame component 525 is capable of, configured to, or operable to support a means for transmitting, via a second communication link between the first wireless device 520 and a third wireless device, a first frame that includes at least one of a first MAC address of a first wireless STA affiliated with the first wireless device 520 or a link identifier associated with a first communication link on which the first wireless STA intends to communicate with a second wireless STA affiliated with a second wireless device. The second frame component is capable of, configured to, or operable to support a means for receiving, via the second communication link between the first wireless device 520 and the third wireless device, a second frame that includes at least one of a second MAC address of the second wireless STA or the link identifier associated with the first communication link on which the second wireless STA intends to communicate with the first wireless STA.

In some implementations, the first frame includes a first FT Action frame, and the second frame includes a second FT Action frame. In some implementations, a Link ID subfield of a STA Control field in a Per-STA Profile subelement of a Link Info field in a Multi-Link element of the first FT Action frame includes the link identifier associated with the first communication link on which the first wireless STA intends to communicate with the second wireless STA.

In some implementations, all subfields of the STA Control field, except for the Link ID subfield and a STA MAC Address Present subfield, are set to zero (0). In some implementations, a STA Profile field is omitted from the Per-STA Profile subelement of the Link Info field in the Multi-Link element of the first FT Action frame.

In some implementations, a STA MAC Address subfield of a STA Info field in a Per-STA Profile subelement of a Link Info field in a Multi-Link element of the first FT Action frame includes the first MAC address of the first wireless STA affiliated with the first wireless device 520.

In some implementations, a Link ID subfield of a STA Control field in a Per-STA Profile subelement of a Link Info field in a Multi-Link element of the second FT Action frame includes the link identifier associated with the first communication link on which the second wireless STA intends to communicate with the first wireless STA.

In some implementations, all subfields of the STA Control field, except for the Link ID subfield and a STA MAC Address Present subfield, are set to zero (0). In some implementations, a STA Profile field is omitted from the Per-STA Profile subelement of the Link Info field in the Multi-Link element of the second FT Action frame.

In some implementations, a STA MAC Address subfield of a STA Info field in a Per-STA Profile subelement of a Link Info field in a Multi-Link element of the second FT Action frame includes the second MAC address of the second wireless STA affiliated with the second wireless device.

In some implementations, a STA MAC Address subfield of a STA Info field in a Per-STA Profile subelement of a Multi-Link element in the second FT Action frame includes the second MAC address of the second wireless STA affiliated with the second wireless device.

In some implementations, the first FT Action frame includes an FT Request frame or an FT Confirm frame, and the second FT Action frame includes an FT Response frame or an FT Ack frame.

In some implementations, the link configuration component 535 is capable of, configured to, or operable to support a means for receiving an indication of a link configuration associated with the second wireless device before initiating an FT frame exchange between the first wireless device 520 and the second wireless device. In some implementations, the link configuration indicates one or more communication links that are enabled for the second wireless device, one or more link identifiers, or a combination thereof.

In some implementations, the connection establishment component 540 is capable of, configured to, or operable to support a means for establishing a connection between the first wireless STA and the second wireless STA in accordance with the first frame and the second frame based on exchanging one or more frames via the first communication link and the first communication link.

In some implementations, to support exchanging the one or more frames, the reassociation request component 545 is capable of, configured to, or operable to support a means for transmitting a Reassociation Request frame via the first communication link in accordance with the first frame. In some implementations, to support exchanging the one or more frames, the reassociation response component 550 is capable of, configured to, or operable to support a means for receiving a Reassociation Response frame via the first communication link in accordance with the second frame.

In some implementations, a Link ID subfield of a STA Control field in a per-STA subelement of a Link Info field in a Multi-Link element of the first frame includes a value that uniquely identifies the first communication link on which the first wireless STA transmits the Reassociation Request frame.

In some implementations, a Link ID subfield of a STA Control field in a per-STA subelement of a Link Info field in a Multi-Link element of the second frame includes a value that uniquely identifies the first communication link on which the second wireless STA transmits the Reassociation Response frame.

In some implementations, a STA MAC Address subfield of a STA Info field in a Per-STA Profile subelement of a Link Info field in a Multi-Link element of the first frame includes the first MAC address of the first wireless STA that transmits the Reassociation Request frame.

In some implementations, a STA MAC Address subfield of a STA Info field in a Per-STA Profile subelement of a Link Info field in a Multi-Link element of the second frame includes the second MAC address of the second wireless STA that transmits the Reassociation Response frame.

In some implementations, the frame verification component 555 is capable of, configured to, or operable to support a means for verifying, for each communication link of a set of multiple communication links associated with the second wireless device, that a MAC address and one or more fields in the Reassociation Response frame correspond to an AP affiliated with the second wireless device. In some implementations, the one or more fields are included in an RSNE or an RSNXE of the Reassociation Response frame.

In some implementations, the first wireless device 520 includes a non-AP MLD, the second wireless device includes a first AP MLD associated with a current AP serving the first wireless STA, and the third wireless device includes a second AP MLD associated with the second wireless STA. In some implementations, the first wireless device 520 includes an FTO, the second wireless device includes a target FTR, and the third wireless device includes a current FTR.

In some implementations, the first frame is provided from the first wireless device 520 to the second wireless device via the third wireless device in accordance with an over-the-DS FT protocol. In some implementations, at least one of the first wireless device 520, the second wireless device, or the third wireless device supports MLO.

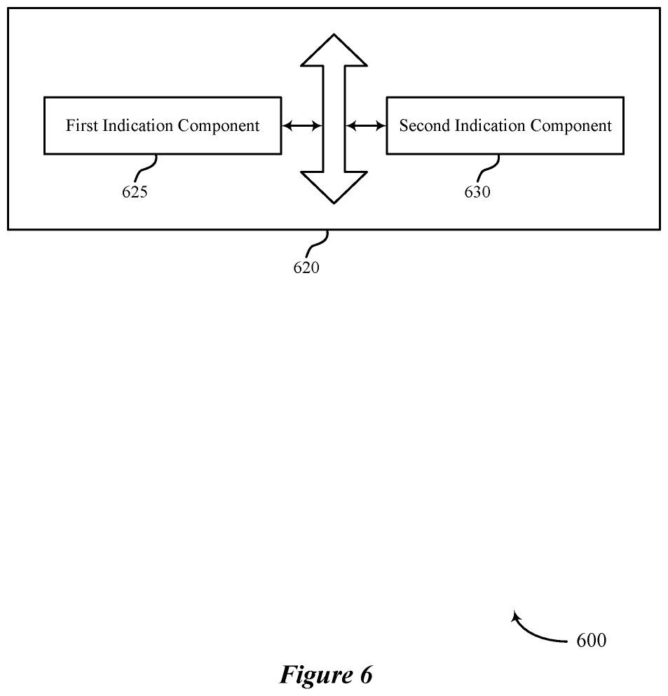

FIG. 6 shows a block diagram 600 of a second wireless device 620 that supports fast transition frame exchanges for MLO. The second wireless device 620 may be an example of aspects of the wireless device 206 shown and described with reference to FIG. 2. The second wireless device 620, or various components thereof, may be an example of means for performing various aspects of fast transition frame exchanges for MLO, as described herein. For example, the second wireless device 620 may include a first indication component 625, a second indication component 630, or any combination thereof. Each of these components, or components or subcomponents thereof (for example, one or more processors, one or more memories), may communicate, directly or indirectly, with one another (for example, via one or more buses).

The first indication component 625 is capable of, configured to, or operable to support a means for receiving, via a third communication link between the second wireless device 620 and a third wireless device, a first frame that includes at least one of a first MAC address of a first wireless STA affiliated with a first wireless device or a link identifier associated with a first communication link on which the first wireless STA intends to communicate with a second wireless STA affiliated with the second wireless device 620. The second indication component 630 is capable of, configured to, or operable to support a means for transmitting, via the third communication link between the second wireless device 620 and the third wireless device, a second frame that includes at least one of a second MAC address of the second wireless STA or the link identifier associated with the first communication link on which the second wireless STA intends to communicate with the first wireless STA.

In some implementations, the first frame includes a first FT Action frame, and the second frame includes a second FT Action frame. In some implementations, a Link ID subfield of a STA Control field in a Per-STA Profile subelement of a Link Info field in a Multi-Link element of the first FT Action frame includes the link identifier associated with the first communication link on which the first wireless STA intends to communicate with the second wireless STA.

In some implementations, a STA MAC Address subfield of a STA Info field in a Per-STA Profile subelement of a Link Info field in a Multi-Link element of the first FT Action frame includes the first MAC address of the first wireless STA affiliated with the first wireless device.

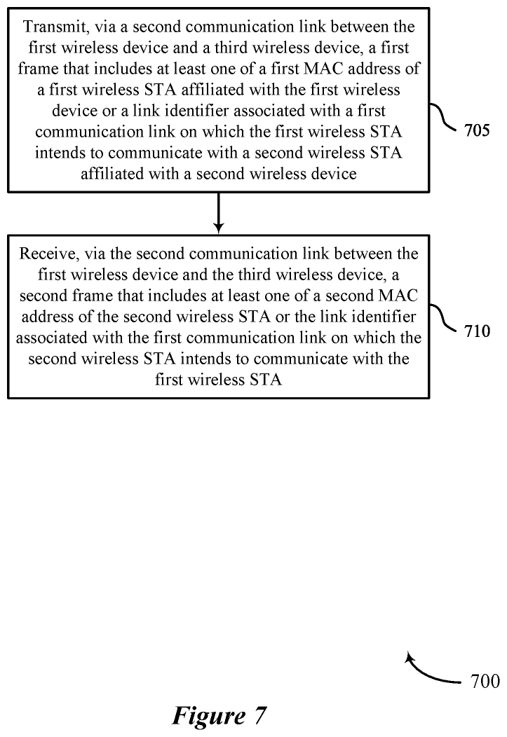

FIG. 7 shows a flowchart illustrating an example process 700 that supports fast transition frame exchanges for MLO. Aspects of the process 700 may be implemented by a first wireless device, such as the wireless device 202 described with reference to FIG. 2. In some implementations, the first wireless device may execute a set of instructions to control functional elements of the first wireless device to perform the described functions. Additionally, or alternatively, the first wireless device may perform aspects of the described functions using special-purpose hardware.

At 705, the first wireless device may transmit, via a second communication link between the first wireless device and a third wireless device, a first frame (such as the first frame 208 shown and described with reference to FIG. 2) that includes at least one of a first MAC address of a first wireless STA affiliated with the first wireless device or a link identifier associated with a first communication link (such as the communication link 220 shown and described with reference to FIG. 2) on which the first wireless STA intends to communicate with a second wireless STA affiliated with a second wireless device. In some implementations, aspects of the operations of 705 may be performed by a first frame component 525, as described with reference to FIG. 5.

At 710, the first wireless device may receive, via the second communication link between the first wireless device and the third wireless device, a second frame (such as the second frame 210 shown and described with reference to FIG. 2) that includes at least one of a second MAC address of the second wireless STA or the link identifier associated with the first communication link on which the second wireless STA intends to communicate with the first wireless STA. In some implementations, aspects of the operations of 710 may be performed by a second frame component 530, as described with reference to FIG. 5.

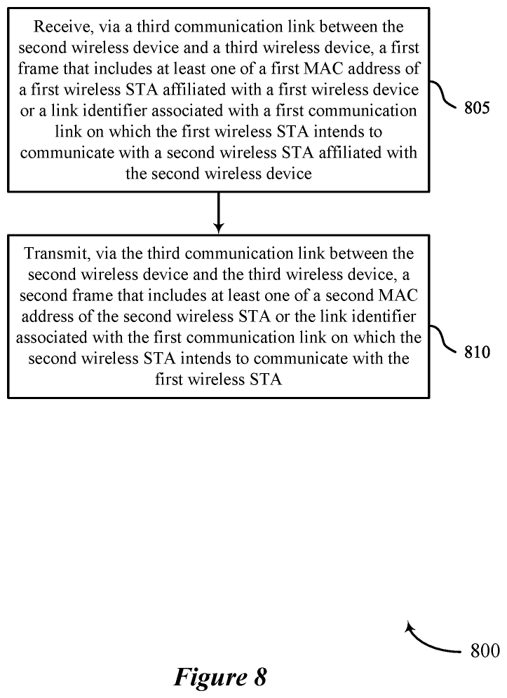

FIG. 8 shows a flowchart illustrating an example process 800 that supports fast transition frame exchanges for MLO. Aspects of the process 800 may be implemented by a second wireless device, such as the wireless device 206 shown and described with reference to FIG. 2. In some implementations, the second wireless device may execute a set of instructions to control functional elements of the second wireless device to perform the described functions. Additionally, or alternatively, the second wireless device may perform aspects of the described functions using special-purpose hardware.

At 805, the second wireless device may receive, via a third communication link between the second wireless device and a third wireless device, a first frame (such as the first frame 208 shown and described with reference to FIG. 2) that includes at least one of a first MAC address of a first wireless STA affiliated with a first wireless device or a link identifier associated with a first communication link on which the first wireless STA intends to communicate with a second wireless STA affiliated with the second wireless device. In some implementations, aspects of the operations of 805 may be performed by a first indication component 625, as described with reference to FIG. 6.

At 810, the second wireless device may transmit, via the third communication link between the second wireless device and the third wireless device, a second frame (such as the second frame 210 shown and described with reference to FIG. 2) that includes at least one of a second MAC address of the second wireless STA or the link identifier associated with the first communication link (such as the communication link 220 shown and described with reference to FIG. 2) on which the second wireless STA intends to communicate with the first wireless STA. In some implementations, aspects of the operations of 810 may be performed by a second indication component 630, as described with reference to FIG. 6.

Implementation examples are described in the following numbered clauses:

Clause 1: A first wireless device, including: one or more memories storing processor executable code; and one or more processors coupled with the one or more memories and individually or collectively operable to execute the code to cause the first wireless device to: transmit, via a second communication link between the first wireless device and a third wireless device, a first frame that includes at least one of a first MAC address of a first wireless STA affiliated with the first wireless device or a link identifier associated with a first communication link on which the first wireless STA intends to communicate with a second wireless STA affiliated with a second wireless device; and receive, via the second communication link between the first wireless device and the third wireless device, a second frame that includes at least one of a second MAC address of the second wireless STA or the link identifier associated with the first communication link on which the second wireless STA intends to communicate with the first wireless STA.

Clause 2: The first wireless device of clause 1, where the first frame includes a first FT Action frame, and the second frame includes a second FT Action frame.

Clause 3: The first wireless device of clause 2, where a Link ID subfield of a STA Control field in a Per-STA Profile subelement of a Link Info field in a Multi-Link element of the first FT Action frame includes the link identifier associated with the first communication link on which the first wireless STA intends to communicate with the second wireless STA.

Clause 4: The first wireless device of clause 3, where all subfields of the STA Control field, except for the Link ID subfield and a STA MAC Address Present subfield, are set to zero (0).

Clause 5: The first wireless device of any of clauses 3 through 4, where a STA profile field is omitted from the Per-STA Profile subelement of the Link Info field in the Multi-Link element of the first FT Action frame.

Clause 6: The first wireless device of any of clauses 2 through 5, where a STA MAC Address subfield of a STA information field in a Per-STA Profile subelement of a Link Info field in a Multi-Link element of the first FT Action frame includes the first MAC address of the first wireless STA affiliated with the first wireless device.

Clause 7: The first wireless device of any of clauses 2 through 6, where a Link ID subfield of a STA Control field in a Per-STA Profile subelement of a Link Info field in a Multi-Link element of the second FT Action frame includes the link identifier associated with the first communication link on which the second wireless STA intends to communicate with the first wireless STA.

Clause 8: The first wireless device of clause 7, where all subfields of the STA Control field, except for the Link ID subfield and a STA MAC Address Present subfield, are set to zero (0).

Clause 9: The first wireless device of any of clauses 7 through 8, where a STA profile field is omitted from the Per-STA Profile subelement of the Link Info field in the Multi-Link element of the second FT Action frame.

Clause 10: The first wireless device of any of clauses 2 through 9, where a STA MAC Address subfield of a STA Info field in a Per-STA Profile subelement of a Link Info field in a Multi-Link element of the second FT Action frame includes the second MAC address of the second wireless STA affiliated with the second wireless device.

Clause 11: The first wireless device of any of clauses 2 through 10, where the first FT Action frame includes an FT Request frame or an FT Confirm frame, and the second FT Action frame includes an FT Response frame or an FT Ack frame.

Clause 12: The first wireless device of any of clauses 1 through 11, where the one or more processors are further operable to individually or collectively execute the code to cause the first wireless device to receive an indication of a link configuration associated with the second wireless device before initiating a FT frame exchange between the first wireless device and the second wireless device.

Clause 13: The first wireless device of clause 12, where the link configuration indicates one or more communication links that are enabled for the second wireless device, one or more link identifiers, or a combination thereof.

Clause 14: The first wireless device of any of clauses 1 through 13, where the one or more processors are further operable to individually or collectively execute the code to cause the first wireless device to establish a connection between the first wireless STA and the second wireless STA in accordance with the first frame and the second frame based on exchanging one or more frames via the first communication link and the first communication link.

Clause 15: The first wireless device of clause 14, where, to exchange the one or more frames, the one or more processors are individually or collectively operable to execute the code to cause the first wireless device to transmit a Reassociation Request frame via the first communication link in accordance with the first frame; and receive a Reassociation Response frame via the first communication link in accordance with the second frame.

Clause 16: The first wireless device of clause 15, where a Link ID subfield of a STA Control field in a per STA subelement of a Link Info field in a Multi-Link element of the first frame includes a value that uniquely identifies the first communication link on which the first wireless STA transmits the Reassociation Request frame.

Clause 17: The first wireless device of any of clauses 15 through 16, where a Link ID subfield of a STA Control field in a per STA subelement of a Link Info field in a Multi-Link element of the second frame includes a value that uniquely identifies the first communication link on which the second wireless STA transmits the Reassociation Response frame.

Clause 18: The first wireless device of any of clauses 15 through 17, where a STA MAC Address subfield of a STA Info field in a Per-STA Profile subelement of a Link Info field in a Multi-Link element of the first frame includes the first MAC address of the first wireless STA that transmits the Reassociation Request frame.

Clause 19: The first wireless device of any of clauses 15 through 18, where a STA MAC Address subfield of a STA Info field in a Per-STA Profile subelement of a Link Info field in a Multi-Link element of the second frame includes the second MAC address of the second wireless STA that transmits the Reassociation Response frame.

Clause 20: The first wireless device of any of clauses 15 through 19, where the one or more processors are further operable to individually or collectively execute the code to cause the first wireless device to verify, for each communication link of a set of multiple communication links associated with the second wireless device, that a MAC address and one or more fields in the Reassociation Response frame correspond to an AP affiliated with the second wireless device.

Clause 21: The first wireless device of clause 20, where the one or more fields are included in a RSNE or a Robust Security RSNXE of the Reassociation Response frame.

Clause 22: The first wireless device of any of clauses 1 through 21, where the first wireless device includes a non AP MLD, the second wireless device includes a first AP MLD associated with a current AP serving the first wireless STA, and the third wireless device includes a second AP MLD associated with the second wireless STA.

Clause 23: The first wireless device of any of clauses 1 through 22, where at least one of the first wireless device, the second wireless device, or the third wireless device supports MLO.

Clause 24: The first wireless device of any of clauses 1 through 23, where the first wireless device includes a FTO, the second wireless device includes a target FTR, and the third wireless device includes a current FTR.

Clause 25: The first wireless device of any of clauses 1 through 24, where information from the first frame is provided to the second wireless device via a third communication link between the third wireless device and the second wireless device in accordance with an over-the-DS FT protocol.

Clause 26: A second wireless device, including: one or more memories storing processor executable code; and one or more processors coupled with the one or more memories and individually or collectively operable to execute the code to cause the second wireless device to: receive, via a third communication link between the second wireless device and a third wireless device, a first frame that includes at least one of a first MAC address of a first wireless STA affiliated with a first wireless device or a link identifier associated with a first communication link on which the first wireless STA intends to communicate with a second wireless STA affiliated with the second wireless device; and transmit, via the third communication link between the second wireless device and the third wireless device, a second frame that includes at least one of a second MAC address of the second wireless STA or the link identifier associated with the first communication link on which the second wireless STA intends to communicate with the first wireless STA.

Clause 27: The second wireless device of clause 26, where the first frame includes a first FT Action frame, and the second frame includes a second FT Action frame.

Clause 28: The second wireless device of clause 27, where a Link ID subfield of a STA Control field in a Per-STA Profile subelement of a Link Info field in a Multi-Link element of the first FT Action frame includes the link identifier associated with the first communication link on which the first wireless STA intends to communicate with the second wireless STA.

Clause 29: The second wireless device of any of clauses 27 through 28, where a STA MAC Address subfield of a STA Info field in a Per-STA Profile subelement of a Link Info field in a Multi-Link element of the first FT Action frame includes the first MAC address of the first wireless STA affiliated with the first wireless device.

Clause 30: The second wireless device of any of clauses 26 through 29, where information from the second frame is provided to the first wireless device via a second communication link between the third wireless device and the first wireless device in accordance with an over-the-DS FT protocol.

Clause 31: A method for wireless communication by a first wireless device, including: transmitting, via a second communication link between the first wireless device and a third wireless device, a first frame that includes at least one of a first MAC address of a first wireless STA affiliated with the first wireless device or a link identifier associated with a first communication link on which the first wireless STA intends to communicate with a second wireless STA affiliated with a second wireless device; and receiving, via the second communication link between the first wireless device and the third wireless device, a second frame that includes at least one of a second MAC address of the second wireless STA or the link identifier associated with the first communication link on which the second wireless STA intends to communicate with the first wireless STA.

Clause 32: The method of clause 31, where the first frame includes a first FT Action frame, and the second frame includes a second FT Action frame.

Clause 33: The method of clause 32, where a Link ID subfield of a STA Control field in a Per-STA Profile subelement of a Link Info field in a Multi-Link element of the first FT Action frame includes the link identifier associated with the first communication link on which the first wireless STA intends to communicate with the second wireless STA.

Clause 34: The method of clause 33, where all subfields of the STA Control field, except for the Link ID subfield and a STA MAC Address Present subfield, are set to zero (0).

Clause 35: The method of any of clauses 33 through 34, where a STA profile field is omitted from the Per-STA Profile subelement of the Link Info field in the Multi-Link element of the first FT Action frame.

Clause 36: The method of any of clauses 32 through 35, where a STA MAC Address subfield of a STA Info field in a Per-STA Profile subelement of a Link Info field in a Multi-Link element of the first FT Action frame includes the first MAC address of the first wireless STA affiliated with the first wireless device.

Clause 37: The method of any of clauses 32 through 36, where a Link ID subfield of a STA Control field in a Per-STA Profile subelement of a Link Info field in a Multi-Link element of the second FT Action frame includes the link identifier associated with the first communication link on which the second wireless STA intends to communicate with the first wireless STA.

Clause 38: The method of clause 37, where all subfields of the STA Control field, except for the Link ID subfield and a STA MAC Address Present subfield, are set to zero (0).

Clause 39: The method of any of clauses 37 through 38, where a STA profile field is omitted from the Per-STA Profile subelement of the Link Info field in the Multi-Link element of the second FT Action frame.

Clause 40: The method of any of clauses 32 through 39, where a STA MAC Address subfield of a STA Info field in a Per-STA Profile subelement of a Link Info field in a Multi-Link element of the second FT Action frame includes the second MAC address of the second wireless STA affiliated with the second wireless device.

Clause 41: The method of any of clauses 32 through 40, where the first FT Action frame includes an FT Request frame or an FT Confirm frame, and the second FT Action frame includes an FT Response frame or an FT Ack frame.

Clause 42: The method of any of clauses 31 through 41, further including: receiving an indication of a link configuration associated with the second wireless device before initiating a FT frame exchange between the first wireless device and the second wireless device.

Clause 43: The method of clause 42, where the link configuration indicates one or more communication links that are enabled for the second wireless device, one or more link identifiers, or a combination thereof.

Clause 44: The method of any of clauses 31 through 43, further including: establishing a connection between the first wireless STA and the second wireless STA in accordance with the first frame and the second frame based on exchanging one or more frames via the first communication link and the first communication link.

Clause 45: The method of clause 44, where exchanging the one or more frames includes: transmitting a Reassociation Request frame via the first communication link in accordance with the first frame; and receiving a Reassociation Response frame via the first communication link in accordance with the second frame.

Clause 46: The method of clause 45, where a Link ID subfield of a STA Control field in a per STA subelement of a Link Info field in a Multi-Link element of the first frame includes a value that uniquely identifies the first communication link on which the first wireless STA transmits the Reassociation Request frame.

Clause 47: The method of any of clauses 45 through 46, where a Link ID subfield of a STA Control field in a per STA subelement of a Link Info field in a Multi-Link element of the second frame includes a value that uniquely identifies the first communication link on which the second wireless STA transmits the Reassociation Response frame.

Clause 48: The method of any of clauses 45 through 47, where a STA MAC Address subfield of a STA Info field in a Per-STA Profile subelement of a Link Info field in a Multi-Link element of the first frame includes the first MAC address of the first wireless STA that transmits the Reassociation Request frame.

Clause 49: The method of any of clauses 45 through 48, where a STA MAC Address subfield of a STA Info field in a Per-STA Profile subelement of a Link Info field in a Multi-Link element of the second frame includes the second MAC address of the second wireless STA that transmits the Reassociation Response frame.

Clause 50: The method of any of clauses 45 through 49, further including: verifying, for each communication link of a set of multiple communication links associated with the second wireless device, that a MAC address and one or more fields in the Reassociation Response frame correspond to an AP affiliated with the second wireless device.

Clause 51: The method of clause 50, where the one or more fields are included in a RSNE or a Robust Security RSNXE of the Reassociation Response frame.

Clause 52: The method of any of clauses 31 through 51, where the first wireless device includes a non AP MLD, the second wireless device includes a first AP MLD associated with a current AP serving the first wireless STA, and the third wireless device includes a second AP MLD associated with the second wireless STA.

Clause 53: The method of any of clauses 31 through 52, where at least one of the first wireless device, the second wireless device, or the third wireless device supports MLO.

Clause 54: The method of any of clauses 31 through 53, where the first wireless device includes a FTO, the second wireless device includes a target FTR, and the third wireless device includes a current FTR.

Clause 55: The method of any of clauses 31 through 54, where the first frame is provided from the first wireless device to the second wireless device via the third wireless device in accordance with an over-the-DS FT protocol.

Clause 56: A method for wireless communication by a second wireless device, including: receiving, via a third communication link between the second wireless device and a third wireless device, a first frame that includes at least one of a first MAC address of a first wireless STA affiliated with a first wireless device or a link identifier associated with a first communication link on which the first wireless STA intends to communicate with a second wireless STA affiliated with the second wireless device; and transmitting, via the third communication link between the second wireless device and the third wireless device, a second frame that includes at least one of a second MAC address of the second wireless STA or the link identifier associated with the first communication link on which the second wireless STA intends to communicate with the first wireless STA.

Clause 57: The method of clause 56, where the first frame includes a first FT Action frame, and the second frame includes a second FT Action frame.

Clause 58: The method of clause 57, where a Link ID subfield of a STA Control field in a Per-STA Profile subelement of a Link Info field in a Multi-Link element of the first FT Action frame includes the link identifier associated with the first communication link on which the first wireless STA intends to communicate with the second wireless STA.

Clause 59: The method of any of clauses 57 through 58, where a STA MAC Address subfield of a STA Info field in a Per-STA Profile subelement of a Link Info field in a Multi-Link element of the first FT Action frame includes the first MAC address of the first wireless STA affiliated with the first wireless device.

Clause 60: A computer program including instructions that, when individually or collectively executed by one or more processors, cause the one or more processors to perform a method of any one of clauses 31 through 55.

Clause 61: A computer program including instructions that, when individually or collectively executed by one or more processors, cause the one or more processors to perform a method of any one of clauses 56 through 59.

As used herein, the term “determine” or “determining” encompasses a wide variety of actions and, therefore, “determining” can include calculating, computing, processing, deriving, investigating, looking up (such as via looking up in a table, a database or another data structure), inferring, ascertaining, measuring, and the like. Also, “determining” can include receiving (such as receiving information), accessing (such as accessing data stored in memory), transmitting (such as transmitting information) and the like. Also, “determining” can include resolving, selecting, obtaining, choosing, establishing and other such similar actions.

As used herein, a phrase referring to “at least one of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b.

As used herein, “based on” is intended to be interpreted in the inclusive sense, unless otherwise explicitly indicated. For example, “based on” may be used interchangeably with “based at least in part on,” “associated with”, or “in accordance with” unless otherwise explicitly indicated. Specifically, unless a phrase refers to “based on only ‘a,’” or the equivalent in context, whatever it is that is “based on ‘a,”’ or “based at least in part on ‘a,’” may be based on “a” alone or based on a combination of “a” and one or more other factors, conditions or information.

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The various illustrative components, logic, logical blocks, modules, circuits, operations and algorithm processes described in connection with the examples disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some implementations be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A first wireless device, comprising:
one or more memories storing processor-executable code; and
one or more processors coupled with the one or more memories and individually or collectively operable to execute the code to cause the first wireless device to:
transmit, via a second communication link between the first wireless device and a third wireless device, a first frame that includes at least one of a first medium access control (MAC) address of a first wireless station (STA) affiliated with the first wireless device or a link identifier associated with a first communication link on which the first wireless STA intends to communicate with a second wireless STA affiliated with a second wireless device; and
receive, via the second communication link between the first wireless device and the third wireless device, a second frame that includes at least one of a second MAC address of the second wireless STA or the link identifier associated with the first communication link on which the second wireless STA intends to communicate with the first wireless STA.

2. The first wireless device of claim 1, wherein the first frame comprises a first Fast Basic Service Set (BSS) Transition (FT) Action frame, and the second frame comprises a second FT Action frame.

3. The first wireless device of claim 2, wherein a Link ID subfield of a STA Control field in a Per-STA Profile subelement of a Link Info field in a Multi-Link element of the first FT Action frame includes the link identifier associated with the first communication link on which the first wireless STA intends to communicate with the second wireless STA.

4. The first wireless device of claim 2, wherein a STA MAC Address subfield of a STA information field in a Per-STA Profile subelement of a Link Info field in a Multi-Link element of the first FT Action frame includes the first MAC address of the first wireless STA affiliated with the first wireless device.

5. The first wireless device of claim 2, wherein a Link ID subfield of a STA Control field in a Per-STA Profile subelement of a Link Info field in a Multi-Link element of the second FT Action frame includes the link identifier associated with the first communication link on which the second wireless STA intends to communicate with the first wireless STA.

6. The first wireless device of claim 2, wherein a STA MAC Address subfield of a STA Info field in a Per-STA Profile subelement of a Link Info field in a Multi-Link element of the second FT Action frame includes the second MAC address of the second wireless STA affiliated with the second wireless device.

7. The first wireless device of claim 2, wherein the first FT Action frame comprises an FT Request frame or an FT Confirm frame, and the second FT Action frame comprises an FT Response frame or an FT Ack frame.

8. The first wireless device of claim 1, wherein the one or more processors are further operable to individually or collectively execute the code to cause the first wireless device to:
receive an indication of a link configuration associated with the second wireless device before initiating a Fast Basic Service Set (BSS) Transition (FT) frame exchange between the first wireless device and the second wireless device.

9. The first wireless device of claim 1, wherein the one or more processors are further operable to individually or collectively execute the code to cause the first wireless device to:
establish a connection between the first wireless STA and the second wireless STA in accordance with the first frame and the second frame based at least in part on exchanging one or more frames via the first communication link and the first communication link.

10. The first wireless device of claim 9, wherein, to exchange the one or more frames, the one or more processors are individually or collectively operable to execute the code to cause the first wireless device to:
transmit a Reassociation Request frame via the first communication link in accordance with the first frame; and
receive a Reassociation Response frame via the first communication link in accordance with the second frame.

11. The first wireless device of claim 10, wherein a Link ID subfield of a STA Control field in a per-STA subelement of a Link Info field in a Multi-Link element of the first frame comprises a value that uniquely identifies the first communication link on which the first wireless STA transmits the Reassociation Request frame.

12. The first wireless device of claim 10, wherein a Link ID subfield of a STA Control field in a per-STA subelement of a Link Info field in a Multi-Link element of the second frame comprises a value that uniquely identifies the first communication link on which the second wireless STA transmits the Reassociation Response frame.

13. The first wireless device of claim 10, wherein a STA MAC Address subfield of a STA Info field in a Per-STA Profile subelement of a Link Info field in a Multi-Link element of the first frame comprises the first MAC address of the first wireless STA that transmits the Reassociation Request frame.

14. The first wireless device of claim 10, wherein a STA MAC Address subfield of a STA Info field in a Per-STA Profile subelement of a Link Info field in a Multi-Link element of the second frame comprises the second MAC address of the second wireless STA that transmits the Reassociation Response frame.

15. The first wireless device of claim 10, wherein the one or more processors are further operable to individually or collectively execute the code to cause the first wireless device to:
verify, for each communication link of a plurality of communication links associated with the second wireless device, that a MAC address and one or more fields in the Reassociation Response frame correspond to an AP affiliated with the second wireless device.

16. The first wireless device of claim 1, wherein the first wireless device comprises a non-access point (AP) multi-link device (MLD), the second wireless device comprises a first AP MLD associated with a current AP serving the first wireless STA, and the third wireless device comprises a second AP MLD associated with the second wireless STA.

17. The first wireless device of claim 1, wherein the first wireless device comprises a Fast Basic Service Set (BSS) Transition (FT) Originator (FTO), the second wireless device comprises a target Fast Basic Service Set (BSS) Transition (FT) Responder (FTR), and the third wireless device comprises a current FTR.

18. The first wireless device of claim 1, wherein information from the first frame is provided to the second wireless device via a third communication link between the third wireless device and the second wireless device in accordance with an over-the-Distribution System (DS) Fast Basic Service Set (BSS) Transition (FT) protocol.

19. A second wireless device, comprising:
one or more memories storing processor-executable code; and
one or more processors coupled with the one or more memories and individually or collectively operable to execute the code to cause the second wireless device to:
receive, via a third communication link between the second wireless device and a third wireless device, a first frame that includes at least one of a first medium access control (MAC) address of a first wireless station (STA) affiliated with a first wireless device or a link identifier associated with a first communication link on which the first wireless STA intends to communicate with a second wireless STA affiliated with the second wireless device; and
transmit, via the third communication link between the second wireless device and the third wireless device, a second frame that includes at least one of a second MAC address of the second wireless STA or the link identifier associated with the first communication link on which the second wireless STA intends to communicate with the first wireless STA.

20. A method for wireless communication by a first wireless device, comprising:
transmitting, via a second communication link between the first wireless device and a third wireless device, a first frame that includes at least one of a first medium access control (MAC) address of a first wireless station (STA) affiliated with the first wireless device or a link identifier associated with a first communication link on which the first wireless STA intends to communicate with a second wireless STA affiliated with a second wireless device; and
receiving, via the second communication link between the first wireless device and the third wireless device, a second frame that includes at least one of a second MAC address of the second wireless STA or the link identifier associated with the first communication link on which the second wireless STA intends to communicate with the first wireless STA.
